(19) United States
(12) Patent Application Publication
(10) Pub. No.: US 2026/0356263 A1
(43) Pub. Date: Nov. 12, 2026

(54) REMOVABLE SEAT TRIM

(71) Applicant: Re:Car Inc., Troy, MI (US)

(72) Inventors: Sandra Cun, El Monte, CA (US); Manasi Pore, Royal Oak, MI (US); Chris Nichols, Detroit, MI (US); Ron Kaip, Rochester Hills, MI (US)

(21) Appl. No.: 19/643,346

(22) Filed: Apr. 9, 2026

Related U.S. Application Data
(60) Provisional application No. 63/786,906, filed on Apr. 10, 2025.

(51) Int. Cl. B60N 2/58

(52) U.S. Cl. CPC B60N 2/5833

(57) ABSTRACT

A removable seat trim for a vehicle seat. The removable seat trim comprises one or more trim elements that each envelope two or more sides respectively of a back portion, a base portion, and/or a headrest of the vehicle seat, each of the one or more trim elements comprising one or more parting lines and one or more fasteners that secure the one or more parting lines. The one or more parting lines extend along two or more sides of the one or more trim elements.

### CROSS-REFERENCE TO RELATED APPLICATIONS

The present application claims benefit to U.S. Provisional Application No. 63/786,906, filed Apr. 10, 2025, which is incorporated herein by reference in its entirety.

### FIELD

The present teachings generally relate to a removable seat trim for a vehicle.

### BACKGROUND

Seat covers are generally known for providing a barrier to protect original equipment manufacturer (OEM) seat trims against stains, debris, abrasion, damage, or otherwise, or to modify the appearance of seats. These seat covers are disposed over OEM seat trim by various methods and have varying degrees of fit to the contours of the seat.

In many cases, seat covers are merely draped over surfaces primarily contacted by occupants and loosely secured to the seat, such as via straps or elastic bands. In this regard, the protective function is served, but complexity and accompanying expense is spared by relatively crude fitting to the seat. These looser-fitting options are often susceptible to shifting relative to the seat surface.

Some covers are of monolithic construction, to cover a seat back and a headrest, a seat back and a seat base, or some combination thereof. However, these varieties can limit headrest adjustment or are visually apparent to be seat covers, which is not always desirable.

Some seat covers are configured in overall dimensions to fit seats of a plurality of vehicle makes and models. In this regard, this one-size-fits-all approach leads to covers fitting snug on some seats and loose on others.

Some seat covers are designed to envelope the seat, at least partially, but can also be loose fitting and/or be susceptible to shifting. One challenge with the variety of enveloping seat cover that fits tighter to the seat is with material selection that allows it to be stretched over the complex surface geometry of a seat, and in this regard, some degree of elasticity is often relied upon, which can limit material selection. Even with these varieties, some regions of the fit may not be tight to the seat or may become looser over time as the seat is used.

An additional challenge particularly with modern vehicles is the provision of seat-borne airbags that deploy from the sides of the seat back or the seat base. Such airbags should be free to deploy in an impact event.

OEM seat trims are form-fit upholstered to the structure of the seat and secured well in place. In this regard, they are not adapted or configured for ease of removal. Accordingly, trim design is generally not customizable beyond the factory without great expense and professional services. In many circumstances removal of OEM seat trim may void warranties or at least may be discouraged due to sensitive vehicle systems on-board seats, such as climate systems, occupant sensors, and safety systems.

It would be desirable to provide a removable seat trim that functions as a seat trim rather than a cover over existing seat trim.

It would be desirable to provide a removable seat trim that is simple to apply to a seat and remove from the seat, while also being able to securely engage with the seat and form-fit to the structure of the seat and surface geometry of the seat.

It would be desirable to provide a removable seat trim that accommodates air bag functionality.

### SUMMARY

The present disclosure relates to a seat cover, which may address at least some of the needs identified above. The removable seat trim may comprise one or more trim elements, each of the one or more trim elements comprising one or more parting lines and one or more first fasteners that connect the one or more parting lines. The one or more parting lines of at least the back portion and the base portion extend along two or more sides of the one or more trim elements. The one or more trim elements may envelope two or more sides respectively of a back portion, a base portion, or a headrest of the vehicle seat, or any combination thereof.

The removable seat trim may directly contact, at least in one or more regions, a comfort layer (e.g., foam, batting, gel, or any combination thereof) of the vehicle seat.

The one or more trim elements may include: a back cover that envelopes at least a front side and a back side of the back portion; a base cover that envelopes at least a top side and one or more lateral sides of the base portion; a headrest cover that envelopes at least a front side and a back side of a headrest of the vehicle seat; or any combination thereof.

The one or more trim elements may have an A-side and a B-side. One or more second fasteners may be located on the B-side and may be adapted and configured to locate on corresponding one or more second fasteners on an A-side of the vehicle seat.

The one or more second fasteners of the one or more trim elements may be loop-style fasteners and the one or more second fasteners of the vehicle seat are hook-style fasteners, or vice versa.

The one or more second fasteners may be located in one or more trenches defined into the A-side of the vehicle seat and along one or more seams of the removable seat trim. The one or more seams may be arranged on the removable seat trim to generally align with the one or more trenches of the vehicle seat.

The one or more parting lines may extend along two or more sides of each of the one or more trim elements.

The one or more parting lines may extend along three or more sides of each the one or more trim elements.

The one or more parting lines may extend along four or more sides of each of the one or more trim elements.

The one or more parting lines may include at least one continuous parting line extending along two or more sides of the one or more trim elements.

The one or more parting lines may include at least one parting line extending along one or more faces respectively of one or more sides of the one or more trim elements.

The one or more parting lines may include at least one parting line extending along one or more corners of the one or more trim elements where two sides or faces of the one or more trim elements meet.

The base cover may include a first parting line extending continuously along two or more sides of the base cover, more preferably along three sides thereof. The base cover may include a second parting line extending along one side thereof.

The second parting line may locate in or proximate to a space between the back and base portions of the vehicle seat. The second parting line may join to the back cover.

The first parting line may be located on faces of the two or more sides of the base cover. The first parting line may be located on the faces of the right, front, and left sides of the base cover.

The back cover may include a first parting line extending along a first side of the back cover, a second parting line extending along a second side of the back cover, and a third parting line extending along two or more sides of the back cover, more preferably three sides of the back cover.

The first parting line may be located on a right side of the back cover. The second parting line may be located on a left side of the back cover. The third parting line may extend along the right side, a back side, and the left side of the back cover. An end of the third parting line may terminate at or proximate to an end of the first parting line and/or an end of the third parting line may terminate at or proximate to an end of the second parting line.

The third parting line may be continuous along the right, back, and left sides of the back cover.

The first and second parting lines may extend along corners respectively between the right and front sides, and the left and front sides.

The headrest cover may include a parting line on a bottom side thereof.

The one or more first fasteners may be in the form of a zipper, a hook-and-loop fastener, or both.

The removable seat trim may further comprise one or more burst seams to provide for protrusion of an airbag, upon deployment, located in the vehicle seat.

The one or more burst seams may be defined partially by the zipper of the back cover, the bottom cover, the headrest cover, or any combination thereof. The one or more burst seams may be defined by connection of the tape with the one or more trim elements.

The present disclosure relates to a vehicle seat, which may address at least some of the needs identified above. The vehicle seat may comprise the removable seat trim according to one or any combination of the preceding paragraphs.

The vehicle seat may comprise a foam layer. The removable seat trim may be applied, at least in part, directly to the foam layer.

The removable seat trim may comprise one or more loop-style fasteners and the vehicle seat, preferably the foam layer, may comprise one or more hook-style fasteners, or vice versa.

The foam layer may comprise one or more trenches. The removable seat trim may comprise one or more seams. The one or more seams may locate at least partially within the one or more trenches. The one or more loop-style fasteners may be located in at least some of the one or more trenches and the one or more hook-style fasteners may be located on at least some of the seams, or vice versa.

The vehicle seat may be comprised by a vehicle. The vehicle may be an electric vehicle. The vehicle may be a reconfigurable vehicle.

### BRIEF DESCRIPTIONS OF THE DRAWINGS

FIG. 1 is a perspective view of a vehicle seat with a removable seat trim according to the present teachings.

FIG. 2A is a plan view of a seat back with a removable seat trim according to the present teachings.

FIG. 2B is a plan view of a seat base with a removable seat trim according to the present teachings.

FIG. 3 is a perspective view of a seat according to the present teachings.

FIG. 4 is a plan view of a fastener according to the present teachings.

FIG. 5 illustrates interchanging removable seat trims according to the present teachings.

FIG. 6A is a perspective view of a removable seat trim according to the present teachings.

FIG. 6B is a perspective view of a removable seat trim according to the present teachings.

FIG. 6C is a perspective view of a removable seat trim according to the present teachings.

FIG. 6D is a perspective view of a removable seat trim according to the present teachings.

### DETAILED DESCRIPTION

The seat cover described herein may be understood as adapted and configured for use with a vehicle having modular characteristics to aid end-users in customizing their vehicle. Although, the present teachings are not intended to be limited to use of the seat cover with only said vehicle. In regard to the modular vehicle, the seat covers described herein may be the only cover or sheet material on the seat. That is, the seat covers described herein may not be placed over an existing cover or sheet material, provided by the original equipment manufacturer. Although, it is contemplated that the present seat covers could be used in this way. The present seat covers may be engaged directly with a comfort layer (e.g., a foam layer) in a seat. The seat covers and/or comfort layer may comprise one or more fastening mechanisms (e.g., hook and loop fasteners) in order to fasten the seat covers to the comfort layer.

The vehicle seat may comprise a back portion, a base portion, and optionally a headrest portion. The vehicle seat may comprise a frame that defines the general structure of the seat. One or more comfort layers may be disposed onto the frame. The one or more comfort layers may function as a cushion upon which an occupant is supported and provides a soft, comfortable feel. The one or more comfort layers may comprise foam, batting, gel, or any combination thereof.

The vehicle seat and the removable seat trim may include an A-side and a B-side. Generally, the A-side may be oriented toward an occupant of the vehicle seat, or outward and away from a center of the seat and the B-side may be in an opposing relationship to the A-side. The A-side of the vehicle seat may contact, at least in part, and/or may be oriented toward a B-side of the removable seat trim. A-side and B-side may be referred to herein for other elements as well with respect to orientations thereof.

The vehicle seat and the removable seat trim may comprise one or more sides. The sides described herein may correspond between the vehicle seat and the removable seat trim, understanding that the removable seat trim form-fits the vehicle seat. The back portion/cover may comprise a front side oriented toward the occupant, an opposing back side, a right side, a left side, a top side, a bottom side, or any combination thereof. The base portion/cover may comprise a top side oriented toward the occupant, an opposing bottom side, a right side, a left side, a front side, a back side, or any combination thereof. The headrest portion/cover may comprise a front side oriented toward the occupant, an opposing back side, a right side, a left side, a top side, a bottom side, or any combination thereof. The general orientations of the various sides may be understood in reference to the illustrated examples herein.

Each side may be defined by a face and two or more corners. The face may be between the one or more corners. Each corner may be defined by a joint between two or more sides. In this regard, by way of example but not limitation, a front face of the back cover may be defined between front right, front top, and front left corners, and said corners may also define the right, top, and left faces. The corners may be sharp or rounded.

The various sides may meet at one or more seams or one or more parting lines described herein, or one or more transitions between the various sides may be defined by a continuum of material. A combination of the foregoing is also contemplated.

The removable seat trim may comprise one or more trim elements. The one or more trim elements may include a back cover, a base cover, a headrest cover, or any combination thereof. Removable seat trim may refer herein to a back cover, a base cover, a headrest cover, or some combination thereof. The removable seat trim may be at least partially enveloped by the back cover, the base cover, the headrest cover, or any combination thereof. In this regard, the one or more trim elements may envelope two or more sides of the seat, preferably four or more sides of the seat. Preferably, the one or more trim elements may envelope at least all readily visible portions of the seat. As described herein, the one or more trim elements may function as the primary trim layer of the seats, and to cover any underlying structure of the seat.

The back cover may envelope a front side, a back side, a right side, and a left side of the back portion of the vehicle seat, or any combination thereof. The base cover may envelope a top side, a right side, a left side, a front side, and a bottom side of the base portion of the vehicle seat, or any combination thereof. The headrest cover may envelope a front side, a back side, a bottom side, a top side, a right side, and a left side of the headrest of the vehicle seat, or any combination thereof.

The removable seat trim may comprise one or more parting lines. The one or more parting lines may define connection locations between separable portions of the removable seat trim. In some examples described herein, the one or more parting lines may be located along one or more corners, along one or more faces, along one or more edges, or any combination thereof.

The one or more parting lines may include one or more continuous parting lines extending along two or more sides of the one or more trim elements. For example, a parting line extending continuously along a first side and a second side.

The one or more parting lines may extend along two or more sides, three or more sides, or even four or more sides of the one or more trim elements.

The base portion may include one or more parting lines, two or more parting lines, or even three or more parting lines. The parting lines may extend along two or more sides, three or more sides, or even four or more sides of the base cover.

The base cover may include a first parting line extending continuously along two or more sides of the base cover, more preferably along three sides thereof. The first parting line may be located on faces of the two or more sides of the base cover. The base cover may include a second parting line extending along one side thereof.

In one exemplary aspect, the base cover may comprise a first parting line located on the faces of the right, front, and left sides of the base cover, preferably continuously along said faces, and a second parting line located in or proximate to a space between the back and base portions of the vehicle seat. The second parting line may be joined to the back cover.

In one exemplary aspect, the base cover may comprise a first parting line located on corners of the right, front, and left sides of the base cover, preferably continuously along said corners. The corners may be, respectively, right top, front top, and left top corners.

The back cover may include one or more parting lines, two or more parting lines, or even three or more parting lines. The parting lines may extend along two or more sides, three or more sides, or even four or more sides of the back cover.

In one exemplary aspect, the back cover may comprise a first parting line extending along a first side of the back cover. The back cover may comprise a second parting line extending along a second side of the back cover. The back cover may comprise a third parting line extending along two or more sides of the back cover. The parting line may extend along three sides of the back cover. The first parting line may extend along a right front corner of the back cover. The second parting line may extend along a left front corner of the back cover. The third parting line may extend continuously along right, back, and left sides of the back cover. The third parting line may extend along faces thereof.

In one exemplary aspect, the back cover may comprise a parting line extending continuously along two or more sides of the back cover. The back cover may comprise a parting line extending continuously along three sides of the back cover. The parting line may extend along corners of the back cover. The parting line may extend along a front right corner, a top right corner, a top back corner, a top left corner, and a right front corner of the back cover.

The headrest cover may include one or more parting lines, two or more parting lines, or even three or more parting lines. The parting lines may extend along one or more sides, two or more sides, three or more sides, or even four or more sides of the headrest cover.

In one exemplary aspect, the headrest cover may comprise a parting line extending along a bottom of the headrest cover. The parting line may extend along a face of the headrest cover.

In one exemplary aspect, the headrest cover may comprise a continuous parting line on two or more, or more preferably three or more sides of the headrest cover. The parting line may extend along a front right side of the headrest cover, a top right side of the headrest cover, a top back side of the headrest cover, a top left side of the headrest cover, a front left side of the headrest cover, a bottom left side of the headrest cover, a bottom back side of the headrest cover, and a bottom right side of the headrest cover.

The one or more parting lines may be located to facilitate a form fit of the removable seat trim to the seat, to locate in regions best accommodating occupant comfort with respect to the fasteners described herein, to accommodate the function of air bags as described herein, or any combination thereof. Thus, the removable seat trim may be closely mated to the contours of the seat and there need not be any slack, elasticity, or otherwise in the material of the removable seat trim to facilitate fitting the removable seat trim with the seat. While these features may not be needed for fitting, the present teachings do not foreclose the inclusion of slack, elasticity, or otherwise in the material.

It is also contemplated by the present teachings that the fit of the removable seat trim is distinguishable from conventional seat covers that are locatable over existing OEM trim material, at least in the sense that the fit of the removable seat trim of the present disclosure is adapted and configured to contact directly, at least in some regions, the one or more comfort layers and optionally exert some degree of compression of the one or more comfort layers to an effect that slack is at least substantially mitigated and all or substantially all portions of the removable seat trim has the appearance of being in taut.

Slack, as referred to herein, may mean one or more regions of excess material that do not form a contacting relationship with elements of the seat or are not pulled taut over the seat (e.g., the one or more comfort layers of the seat). The slack may manifest as surface features such as wrinkling, bunching, bubbling, or the like. In other words, the slack may be defined by one or more gaps between the removable seat trim and the seat. However, slack may not refer to gaps that arise from structural features of the seat and/or the removable seat trim. By way of example, a gap between trench lines, air channels, or otherwise in the one or more comfort layers and an overlying portion of removable seat trim may not be understood as having slack if the removable seat trim is taut over the trench lines, air channels, or otherwise.

In consideration of the foregoing, it is to be understood that the removable seat trim of the present teachings may function as the primary trim layer of the seat, as opposed to a secondary cover that is disposed over an existing OEM trim layer. Although, the present teachings do not forego the removable seat trim as being used in such a secondary cover manner. The configuration of the removable seat trim has been crafted to provide a form-fit mating to the underlying elements of the seat, while also being capable of interchangeability by an end-user without special tools, skills, or knowledge.

The removable seat trim may comprise one or more fasteners. The one or more fasteners may connect the one or more parting lines. The one or more fasteners may be in the form of a zipper, a hook-and-loop fastener, or both. The zipper may comprise tape and teeth connected to the tape. The tape may include a first tape segment and a second tape segment, and the teeth may be included on the first and second segments. The tape may be connected to the one or more trim elements, on parting lines. The tape may be sewn, welded, and/or chemically adhered to the one or more trim elements. The hook-and-loop fastener may include a hook-style fastener on a first trim element and a loop-style fastener on a second trim element.

The removable seat trim may comprise one or more burst seams. The one or more burst seams may function to provide for protrusion of an airbag, upon deployment, from a vehicle seat. The one or more burst seams may be defined partially by the zipper of the back cover, the bottom cover, the headrest cover, or any combination thereof. In one exemplary configuration, the one or more burst seams may be defined by connection of the tape of a zipper with the one or more trim elements.

The removable seat trim may comprise one or more flaps. The one or more flaps may function to hide the fasteners connecting the one or more parting lines. The one or more flaps may be connected to the removable seat trim on one side of a parting line.

The removable seat trim and the vehicle seat (e.g., a comfort layer of a seat) may comprise one or more fasteners. The one or more fasteners may function to connect the removable seat trim to the seat. The one or more fasteners may be located on an A-side of the vehicle seat and a B-side of the removable seat trim. The fasteners on the vehicle seat may be adapted and configured to be juxtaposed in location with the fasteners on the removable seat trim. The one or more fasteners of the one or more trim elements may be loop-style fasteners and the one or more fasteners of the vehicle seat are hook-style fasteners, or vice versa.

The vehicle seat may comprise one or more trenches. The trenches may be defined into the comfort layer. The one or more trim elements may comprise one or more seams. The seams may be formed by the connection of separate panels of material. At least some of the seams may be configured and adapted to be juxtaposed with at least some of the trenches. The fasteners connecting the removable seat trim to the seat may be located in one or more trenches and on one or more seams.

The one or more trim elements may comprise a thermal device. The thermal device may be in the form of a heater mat. The thermal device may be located in one or any combination of trim elements described herein.

The one or more trim elements may be fabricated from one or more materials, optionally two or more materials. The one or more trim elements are fabricated from fabric, leather, vinyl, or any combination thereof.

The description herein pertains to automotive vehicles. Preferably, it pertains to a vehicle that can be reconfigured from a first vehicle configuration to a second vehicle configuration. The vehicle can be reconfigured back to the first vehicle configuration. In other words, the vehicle has a reversible configurable structure.

In the context of the present description, “reversibly configurable” refers to structure having ability to be reconfigured (e.g., converted or transformed) from a first configuration to a second configuration and back to the first configuration. In this regard, “reversibly configurable” includes an ability of a structure to be reconfigured without permanently altering the structure in a way that would inhibit the structure from being reconfigured back to a previous configuration. For example, the structure may be reversibly configured from and/or between the first vehicle configuration to a second vehicle configuration without using permanent fasteners like adhesives or welding. For example, the structure may be reversibly configured from and/or between a first vehicle configuration to a second vehicle configuration without the need for using destructive material removal techniques causing permanent deformation such as cutting, milling, grinding, etc.

However, in some configurations, if drilling other insignificant plastic deformation is required to reconfigure the vehicle from or between the first and second vehicle configuration, such drilling is minimal and in accordance with an instruction approved by the original equipment manufacturer so that it avoids compromising structural integrity of the frame, and/or does not interfere with design and/or performance specifications of the original equipment manufacturer. For example, “reversibly configurable” includes an ability of a structure to be reconfigured with only limited drilling of openings in a vehicle structure, such as to receive a fastener in the transformed configuration. However, such drilling of openings does not prevent the structure from being converted or transformed back into a previous configuration.

The conversion of the vehicle from and/or between a first configuration and a second configuration according to these teachings may be accomplished or achieved by using non-permanent mechanical connections (e.g., mechanical fasteners, mechanical interlocks, bolts, screws, weld nuts, clamps, and/or friction fits). In this way, the reconfiguration may not permanently alter any of the vehicle components such that the vehicle components could not be returned to the previous configuration.

Advantageously, by utilizing non-permanent mechanical connections to add, remove, or reposition vehicle components during the reconfiguration or conversion, end users without access to complicated tools, machinery, and/or fabricating techniques can reconfigured the vehicle. Instead, common tool such as sockets, ratchets, wrenches, screw drivers, and the like can be used to reconfigure the vehicle, without the need for complicated and expensive tools, machinery, and/or fabricating techniques, such as, for example grinders, cutters, welders, etc.

The conversion of the vehicle from the first configuration to the second configuration may be performed after the vehicle has been placed in service by the original equipment manufacturer (OEM) In other words, the OEM may manufacture and offer the vehicle for sale in the first vehicle configuration as original equipment. Then, if a user desires the second vehicle configuration, the user may obtain the rear enclosure assembly and reconfigure the vehicle structure from the original equipment into the second vehicle configuration according to these teachings. The user can also reconfigure the vehicle back to the first vehicle configuration at a later time due to the reversibly configurable nature of the vehicle according to these teachings.

In the context of the present description, “original equipment” includes automotive vehicles and their respective components in a state as assembled during the construction of the vehicles as new vehicles. In contrast, “aftermarket” equipment includes components made by the OEM or by another entity other than the OEM, which might be installed as replacements or enhancements after the car comes out of the OEM factory. Components of the present description may be provided as components of original equipment vehicle, and/or provided as aftermarket components for installation on an original equipment vehicle (optionally using at least some of the hardware provided in the original equipment vehicle).

In the context of the present description, one of the vehicle configurations (e.g., first vehicle configuration or second vehicle configuration) may be a truck or pickup truck configuration. In the context of the present description, the other vehicle configuration (e.g., first vehicle configuration or second vehicle configuration) may be a sport utility vehicle (SUV) configuration.

In the context of the present description, a “pickup truck” includes a vehicle that may be a light, medium-duty, or heavy-duty truck. The pickup truck configuration may include a vehicle having an enclosed cab, cockpit, or occupant compartment (for at least a driver and at least one other occupant) and an open cargo area, namely a bed, located in the rear portion of the vehicle and being operable for storing and/or transporting cargo. A pickup truck configuration may be a vehicle that does not include a C-pillar, e.g., does not include a C-pillar that defines part of a cab. A pickup truck configuration may be a vehicle that does not include a D-pillar. A pickup truck configuration may be a vehicle that has a removable bulk head panel and rear window or glass assembly that can be completely removed or separated from the vehicle. A pickup truck configuration does not include features of a minivan.

In the context of the present description, a “sport utility vehicle” includes a vehicle that may be a light, medium-duty or heavy-duty vehicle including an enclosed cab (for at least a driver and at least one and preferably a plurality of other occupants), a cargo area enclosed by an enclosure, and a space behind a driver seat for or providing additional passenger seating. Thus, a “sport utility vehicle” includes a vehicle that is configured to receive at least one rear seat, at least one seat belt, and at least one air bag (e.g., a side curtain airbag mounted in an upper part of the vehicle adjoining an edge portion of the vehicle roof). When the vehicle is converted into the SUV configuration, C- and D-pillars may be added.

The vehicle in accordance with the present teachings (e.g., pickup truck configuration; SUV configuration, or any other configuration) may include a suspension. The suspension may include a solid axle. The suspension may include a de Dion suspension or axle. The suspension may include coil springs. The coil springs may be located forward or rearward of the solid axle and not on the axle. he suspension may be free of any leaf springs. The suspension may include one or more end plates that are integrally formed with the solid axle. The suspension may include a half shaft that extends from the one or more motors through an opening in the end plate.

The vehicle may include a front wheel drive system, a rear wheel drive system, or a combination of front and rear wheel drive (e.g., all-wheel drive system). As part of the reconfiguration, the vehicle may be converted from a rear wheel drive system to a wrong wheel drive system and/or to an all-wheel drive system.

The vehicle disclosed herein may be powered by an electrified powertrain (e.g., it is free of an internal combustion engine). An electrified powertrain may comprise one or more batteries. The one or more batteries may be chargeable by plugging the vehicle into a charging station and/or with regenerative features while the vehicle is in operation. The vehicle may include one or more wheel corner assemblies that include regenerative braking systems. The vehicle may include a front-wheel drive powertrain, a rear-wheel drive powertrain, or an all-wheel drive powertrain. A factory model of the vehicle may include rear-wheel drive or front-wheel drive, and an end user may install an additional motor or powertrain in the vehicle to convert the vehicle into all-wheel drive. The vehicle may comprise one or more motors, hardware, and/or software that allows for a plug-and-play integration when the powertrain is added or converted from front-wheel drive to rear-wheel drive and/or all-wheel drive, or from rear-wheel drive to front-wheel drive and/or all-wheel drive.

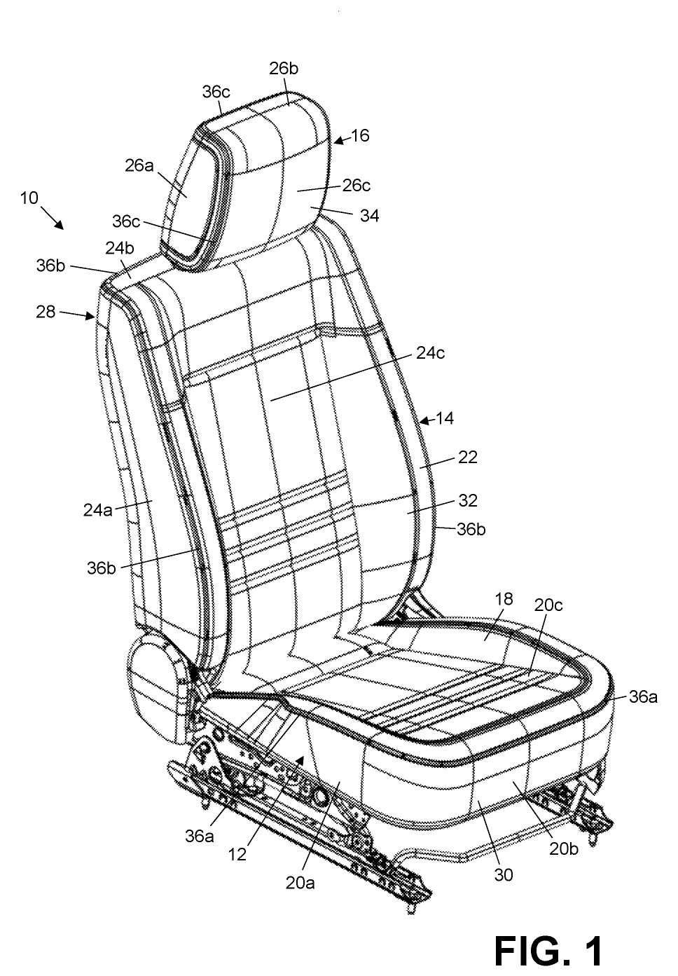

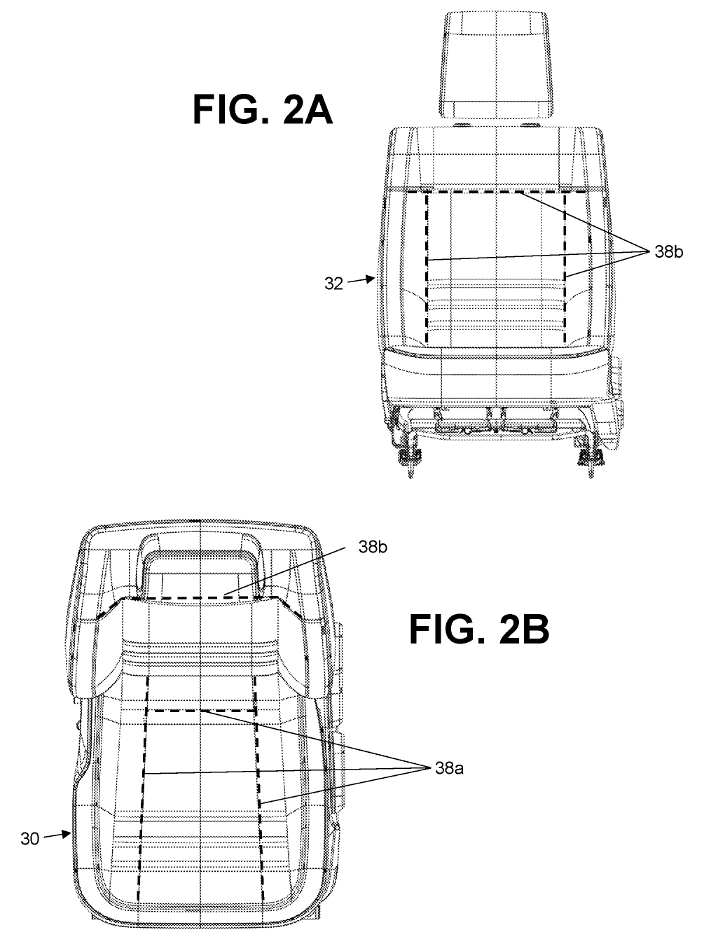

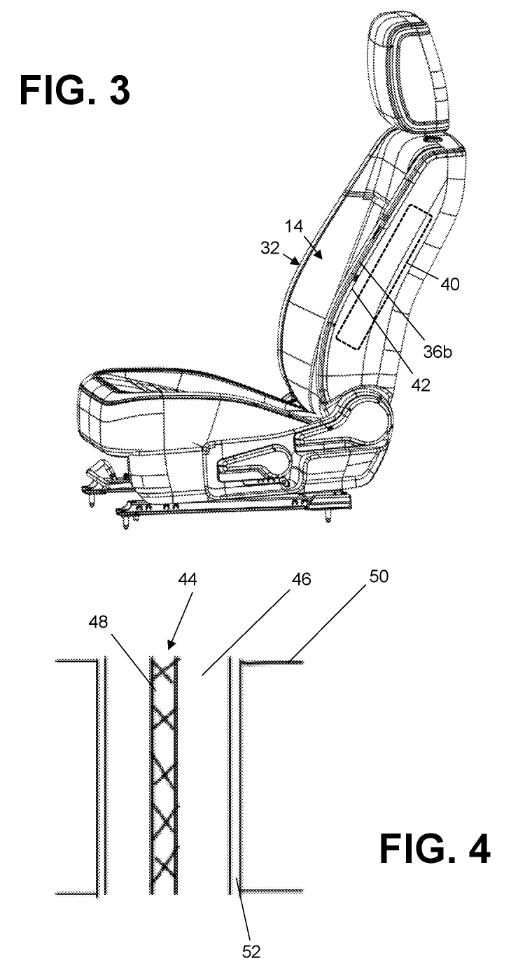

FIGS. 1-3 illustrate a seat 10 comprising a base portion 12, a back portion 14, and a headrest 16.

The base portion 12 comprises bolsters 18 and is defined by a right side 20a, an opposing left side (not shown), a front side 20b, an opposing back side (not shown), a top side 20c, and an opposing back side (not shown). The back portion 14 comprises bolsters 22 and is defined by a right side 24a, an opposing left side (not shown), a top side 24b, an opposing bottom side (not shown), a front side 24c, and an opposing back side (not shown). The headrest 16 is defined by a right side 26a, an opposing left side (not shown), a top side 26b, an opposing bottom side (not shown), a front side 26c, and an opposing back side (not shown).

A removable seat trim 28 extends over the seat 10 and includes a base cover 30, a back cover 32, and a headrest cover 34. Each of the base cover 30, the back cover 32, and the headrest cover 34 comprises a zipper 36a, 36b, 36c. The zippers 36a, 36b, 36c extend along a plurality of the sides and at the interface of adjacent sides. The zipper 36a of the base cover 30 extends along the bolsters 18 and the front side 20b thereof. The zipper 36b of the back cover 32 extends along bolsters 22 and a top side 24b thereof. The zipper 36c of the headrest 16 extends along the right 24a and left (not shown) sides and the top side 24b.

The base cover 30 and the back cover 32 comprise a hook and loop fasteners 38a, 38b that extend along some of the seams of the seat 10, which mate with complementary hook and loop fasteners (not shown) on the seat 10 (e.g., on a comfort layer comprising foam). For example, a hook-style fastener is located on an A-side of the comfort layer (not shown) and a loop-style fastener is located on B-sides of the base and back covers 30, 32, or vice versa. In this regard, the removable seat trim 28 fastens directly to the comfort layer. It is contemplated that hook-and-loop fasteners can be employed for the engagement of the headrest cover 34 to the headrest 16.

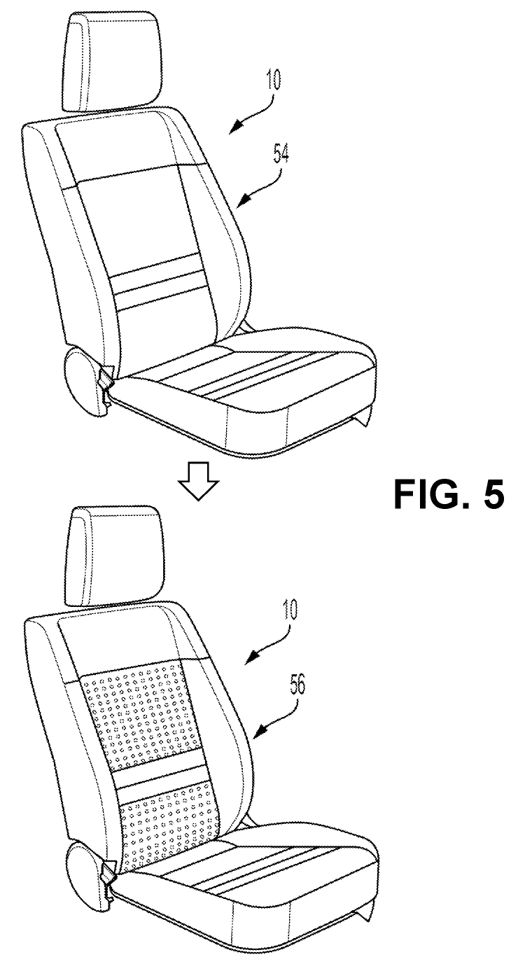

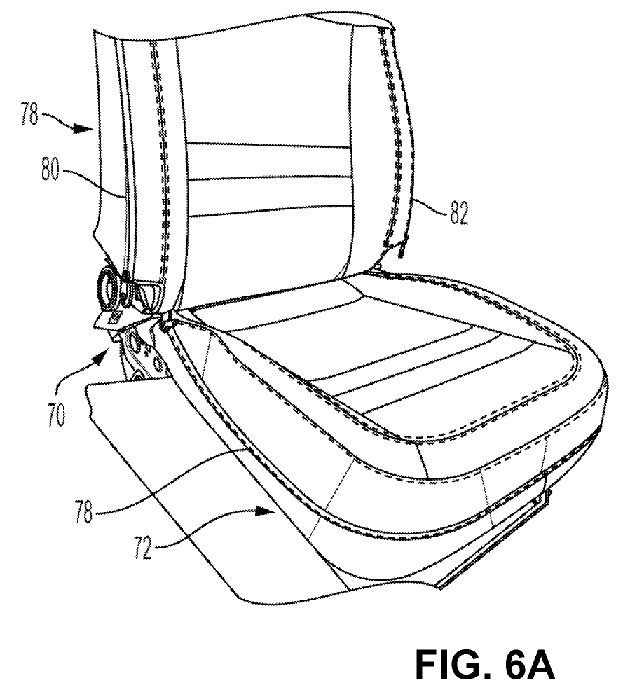

The removable seat trim 28 may be installed by loosely fitting the same to the seat 10 and aligning and engaging the hook-and-loop fasteners of the removable seat trim 28 with the seat 10. The zippers can then be engaged by feeding teeth of a first side of each cover into the appropriate zipper head and then zipping along the parting lines. The removable seat trim 28 may be removed by inverting these steps and applying a different removable seat trim to the seat 10 by the same steps, such as shown in FIG. 5; a removable seat trim 54 is replaced with a removable seat trim 56.

The seat 10 comprises airbags 40. One such airbag 40 is shown in a bolster 22 of the back portion 14 of the seat 10. The present teachings are not intended to be limiting in this regard. One or more airbags may be located anywhere in the seat such as in the base portion, the back portion, or both, and in one or both sides thereof. The back cover 32 comprises a burst seam 42 proximate to the airbag 40 and as a part of the zipper 36b. Upon deployment of the airbag 40, the pressure from the airbag 40 causes the burst seam 42 to separate, so as to not interfere with the deployment of the airbag 40.

FIG. 4 shows an exemplary zipper 44. The zipper 44 comprises tape 46 and teeth 48 that are couplable and un-couplable by a zipper head. The tape 42 functions to provide a surface to which cover material 50 (e.g., fabric, leather, or the like) comprised by the removable seat trim 28 can be attached (e.g., stitched, welded, adhered, etc.). The burst seam 52 is defined by the connection between the tape 46 and the cover material 50. That is, when an airbag deploys, the connection between the tape 46 and the cover material 50, at least in the region of the airbag may be split.

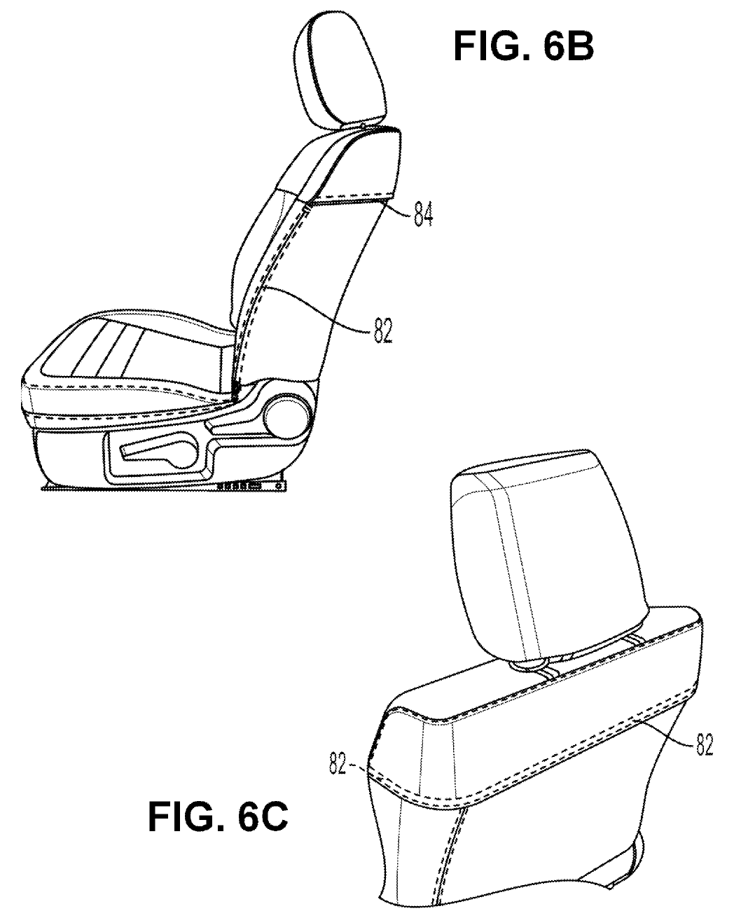

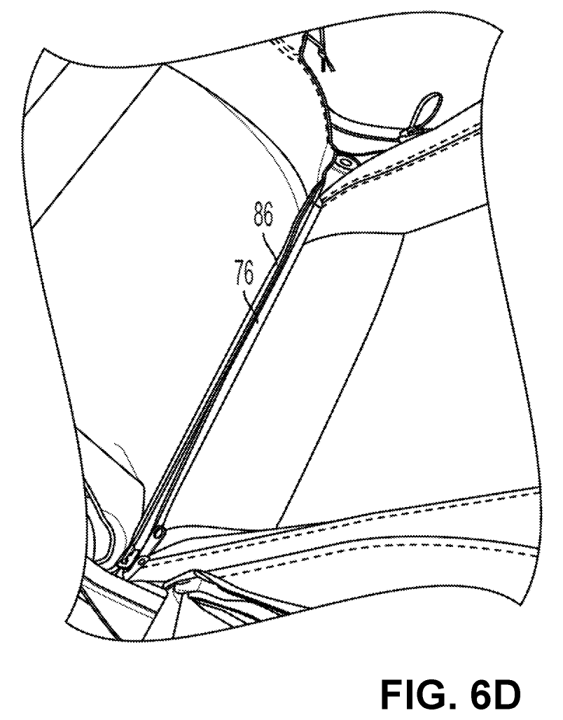

FIGS. 6A-6D show another exemplary removable seat trim 70. The base cover 72 includes a zipper 74 extending along faces of the right, front, and left sides thereof, and a zipper 76 extending along a rear edge thereof, proximate to a bottom edge of the back cover 78.

The back cover 78 comprises a zipper 80 located on a right side thereof, a zipper 82 located on a left side thereof, and a zipper 84 located across the right, back, and left sides thereof. The back cover 78 also comprises a zipper 86 on a bottom edge thereof, which connects to the zipper 76 of the base cover 72 to connect the back and base covers 78, 72.

It is understood that the above description is intended to be illustrative and not restrictive. The explanations and illustrations presented herein are intended to acquaint others skilled in the art with the invention, its principles, and its practical application.

Those skilled in the art may adapt and apply the invention in its numerous forms, as may be best suited to the requirements of a particular use. Many embodiments as well as many applications besides the examples provided herein will be apparent to those of skill in the art upon reading the above description.

Accordingly, the specific embodiments of the invention set forth herein are not intended as being exhaustive or limiting of the teachings. The scope of the invention should, therefore, be determined not with reference to the above description, but should instead be determined with reference to the appended claims, along with the full scope of equivalents to which such claims are entitled.

The omission in the following claims of any aspect of subject matter that is disclosed herein is not a disclaimer of such subject matter, nor should it be regarded that the inventors did not consider such subject matter to be part of the disclosed inventive subject matter.

The disclosures of all articles and references, including patent applications and publications, are incorporated by reference for all purposes.

Plural elements or steps can be provided by a single integrated element or step. Alternatively, a single element or step might be divided into separate plural elements or steps.

The disclosure of “a” or “one” to describe an element or step is not intended to foreclose additional elements or steps.

The use of “about” or “approximately” in connection with a range applies to both ends of the range. Thus, “about 20 to 30” is intended to cover “about 20 to about 30”, inclusive of at least the specified endpoints.

Unless otherwise stated, all ranges include both endpoints and all numbers between the endpoints in increments of one unit provided that there is a separation of at least 2 units between any lower endpoint and any higher endpoint. As an example, if it is stated that the amount of a component, a property, or a value of a process variable such as, e.g., temperature, pressure, time, and the like is, e.g., from 1 to 90, from 20 to 80, or from 30 to 70, it is intended that intermediate range values such as, e.g., 15 to 85, 22 to 68, 43 to 51, 30 to 32, etc., are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest endpoint and the highest endpoint enumerated are to be considered to be expressly stated in this application in a similar manner.

The term “consisting essentially of” to describe a combination shall include the elements or components identified, and such other elements or components that do not materially affect the basic and novel characteristics of the combination. The use of the terms “comprising” or “including” to describe combinations of elements or components herein also contemplates embodiments that consist essentially of the elements or components.

While the terms first, second, third, etc., may be used herein to describe various elements, components, regions, layers, and/or sections, these elements, components, regions, layers, and/or sections should not be limited by these terms. These terms may be used to distinguish one element, component, region, layer, and/or section from another region, layer, and/or section. Terms such as “first,” “second,” and other numerical terms when used herein do not imply a sequence or order unless clearly indicated by the context. Thus, a first element, component, region, layer, and/or section discussed below could be termed a second element, component, region, layer, and/or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the drawings. Spatially relative terms may be intended to encompass different orientations of the device in use or operation in addition to the orientation depicted in the drawings. For example, if the device in the drawings is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terms “generally” or “substantially” to describe angular measurements may mean about +/- 10⁰ or less, about +/- 5⁰ or less, or even about +/- 1⁰ or less. The terms “generally” or “substantially” to describe angular measurements may mean about +/- 0.01⁰ or greater, about +/- 0.1⁰ or greater, or even about +/- 0.5⁰ or greater.

The terms “generally” or “substantially” to describe linear measurements, percentages, or ratios may mean about +/- 10% or less, about +/- 5% or less, or even about +/- 1% or less. The terms “generally” or “substantially” to describe linear measurements, percentages, or ratios may mean about +/- 0.01% or greater, about +/- 0.1% or greater, or even about +/- 0.5% or greater.

### Miscellaneous Examples

Ex. 1. A seat cover for a vehicle seat. The seat cover may comprise a back cover and a base cover. The back cover and the base cover may have an A-side and a B-side. One or more fasteners may be located on the B-side. The one or more fasteners may be adapted and configured to locate on fasteners on an A-side of the vehicle seat.

Ex. 2. The back cover and the base cover may each comprise a zipper extending along two or more edges thereof. A handle of the zipper may locate on a rear inboard region of the vehicle seat when the zipper is completely closed.

Ex. 3. The zipper of the base cover may extend along bolsters thereof and a front edge thereof.

Ex. 4. The zipper of the back cover may extend along bolsters thereof, two opposing side rear edges thereof, and/or a rear top edge thereof.

Ex. 5. The one or more fasteners on the B-side of the seat cover may include a hook-and-loop fastener. The one or more fasteners of the A-side of the vehicle seat may include a hook-and-loop fastener.

Ex. 6. The seat cover may comprise a hook fastener and the vehicle seat may comprise a loop fastener, or vice versa.

Ex. 7. The one or more fasteners of the seat cover may be aligned with seams of the seat cover.

Ex. 8. The seat cover may further comprise a headrest cover.

Ex. 9. The headrest cover may comprise a zipper that extends along a rear bottom edge of a headrest, bottom side edges thereof, front side edges thereof, top side edges thereof, and a top rear edge thereof.

Ex. 10. A handle of the zipper may locate on a top rear edge of the headrest when the zipper is completely closed.

Ex. 11. The seat cover may further comprise one or more burst seams to provide for protrusion of an airbag located in bolsters of a back portion of the seat and optionally bolsters located in a base portion of the seat.

Ex. 12. The burst seam may be defined partially by the zipper of the back cover, the bottom cover, or both.

Ex. 13. The zipper may comprise teeth and a tape. The teeth may be connected to the tape and the tape may function as a structure to be attached (e.g., sewn, welded, adhered) to a sheet material (e.g., fabric, leather, or the like) comprised by the seat cover. The burst seam may be defined by the connection of the tape with the sheet material.

Ex. 14. A vehicle seat may comprise the seat cover according to any one of the preceding paragraphs. The vehicle seat may be free of a sheet material (e.g., fabric or leather) aside from that of the seat cover.

Ex. 15. The vehicle seat may comprise a foam layer. The seat cover may be applied directly to the foam layer.

Ex. 16. The foam layer may comprise a hook-and-loop fastener and the seat cover may comprise a complementary hook-and-loop fastener.

### REFERENCE NUMERALS

10 seat
12 base portion
14 back portion
16 headrest
18 bolsters (base)
20a right side
20b front side
20c top side
22 bolsters (back)
24a right side
24b top side
24c front side
26a right side
26b top side
26c front side
28 removable seat trim
30 base cover
32 back cover
34 headrest cover
36a zipper
36b zipper
36c zipper
38a hook and loop
38b hook and loop
40 airbag
42 burst seam
44 zipper
46 tape
48 teeth
50 cover material
52 burst seam
54 removable seat trim
56 removable seat trim
70 removable seat trim
72 base cover
74 zipper
76 zipper
78 back cover
80 zipper
82 zipper
84 zipper
86 zipper

What is claimed is:

1. A removable seat trim for a vehicle seat, the removable seat trim comprising: one or more trim elements that each envelope two or more sides respectively of a back portion, a base portion, or a headrest of the vehicle seat, or any combination thereof, each of the one or more trim elements comprising one or more parting lines and one or more first fasteners that connect the one or more parting lines; and wherein the one or more parting lines of at least the back portion and the base portion extend along two or more sides of the one or more trim elements.

2. The removable seat trim according to claim 1, wherein the removable seat trim directly contacts, at least in one or more regions, a comfort layer of the vehicle seat.

3. The removable seat trim according to claim 2, wherein the one or more trim elements include: a back cover that envelopes at least a front side and a back side of the back portion; a base cover that envelopes at least a top side and one or more lateral sides of the base portion; a headrest cover that envelopes at least a front side and a back side of a headrest of the vehicle seat; or any combination thereof.

4. The removable seat trim according to claim 3, wherein the one or more trim elements have an A-side and a B-side; wherein one or more second fasteners are located on the B-side and are adapted and configured to locate on corresponding one or more second fasteners on an A-side of the vehicle seat; and wherein the one or more second fasteners of the one or more trim elements are loop-style fasteners and the one or more second fasteners of the vehicle seat are hook-style fasteners, or vice versa.

5. The removable seat trim according to claim 4, wherein the one or more second fasteners are located in one or more trenches defined into the A-side of the vehicle seat and along one or more seams of the removable seat trim; and wherein the one or more seams are arranged on the removable seat trim to generally align with the one or more trenches of the vehicle seat.

6. The removable seat trim according to claim 5, wherein the one or more parting lines extend along two or more sides or three or more sides or four or more sides of each of the one or more trim elements.

7. The removable seat trim according to claim 6, wherein the one or more parting lines include at least one continuous parting line extending along two or more sides of the one or more trim elements.

8. The removable seat trim according to claim 7, wherein the one or more parting lines include at least one parting line extending along one or more faces respectively of one or more sides of the one or more trim elements.

9. The removable seat trim according to claim 7, wherein the one or more parting lines include at least one parting line extending along one or more corners of the one or more trim elements where two sides or faces of the one or more trim elements meet.

10. The removable seat trim according to claim 7, wherein the base cover includes a first parting line extending continuously along two or more sides of the base cover, more preferably along three sides thereof; and a second parting line extending along one side thereo; wherein the second parting line locates in or proximate to a space between the back and base portions of the vehicle seat; and wherein the second parting line joins to the back cover.

11. The removable seat trim according to claim 10, wherein the first parting line is located on faces of the two or more sides of the base cover; and wherein the first parting line is located on the faces of the right, front, and left sides of the base cover.

12. The removable seat trim according to claim 11, wherein the back cover includes a first parting line extending along a first side of the back cover, a second parting line extending along a second side of the back cover, and a third parting line extending along two or more sides of the back cover, more preferably three sides of the back cover.

13. The removable seat trim according to claim 12, wherein the first parting line is located on a right side of the back cover; wherein the second parting line is located on a left side of the back cover; wherein the third parting line extends along the right side, a back side, and the left side of the back cover; wherein an end of the third parting line terminates at or proximate to an end of the first parting line and/or wherein an end of the third parting line terminates at or proximate to an end of the second parting line; wherein the third parting line is continuous along the right, back, and left sides of the back cover; and wherein the first and second parting lines extend along corners respectively between the right and front sides, and the left and front sides.

14. The removable seat trim according to claim 13, wherein the headrest cover includes a parting line on a bottom side thereof.

15. The removable seat trim according to claim 14, wherein the one or more first fasteners are in the form of a zipper, a hook-and-loop fastener, or both.

16. The removable seat trim according to claim 15, further comprising one or more burst seams to provide for protrusion of an airbag, upon deployment, located in the vehicle seat; and wherein the one or more burst seams are defined partially by the zipper of the back cover, the bottom cover, the headrest cover, or any combination thereof; and optionally wherein the one or more burst seams are defined by connection of the tape with the one or more trim elements.

17. A vehicle seat comprising the removable seat trim according to claim 1.

18. The vehicle seat according to claim 17, wherein the vehicle seat comprises a foam layer; and wherein the removable seat trim is applied, at least in part, directly to the foam layer.

19. The vehicle seat according to claim 18, wherein the removable seat trim comprises one or more loop-style fasteners and the vehicle seat, preferably the foam layer, comprises one or more hook-style fasteners, or vice versa.

20. The vehicle seat according to claim 19, wherein the foam layer comprises one or more trenches; wherein the removable seat trim comprises one or more seams; and wherein the one or more seams locate at least partially within the one or more trenches; and optionally wherein the one or more loop-style fasteners are located in at least some of the one or more trenches and the one or more hook-style fasteners are located on at least some of the seams, or vice versa.
